(19) United States
(12) Patent Application Publication
(10) Pub. No.: US 2017/0259726 A1
(43) Pub. Date: Sep. 14, 2017

(54) TIE-DOWN DEVICE

(71) Applicant: Daniel S. MILBY, Boothwyn, PA (US)

(72) Inventor: Daniel S. MILBY, Boothwyn, PA (US)

(21) Appl. No.: 15/387,046

(22) Filed: Dec. 21, 2016

Related U.S. Application Data
(60) Provisional application No. 62/270,830, filed on Dec. 22, 2015.

(51) Int. Cl. B60P 7/08

(52) U.S. Cl. CPC B60P 7/0807

(57) ABSTRACT

A tie-down that incorporates a specific design that can be fanciful or utilitarian (i.e., by conveying a message through its shape). The tie-down can be painted to improve both its functionality or fancifulness. In addition, words/phrases, including warnings or advertisements can also be painted on the tie-down.

### CLAIM FOR PRIORITY

The subject application claims priority under all applicable U.S. statutes, including 35 U.S.C. §119(e), to U.S. Provisional Application Ser. No. 62/270,830, filed Dec. 22, 2015, and titled Tie-Down Device.

### FIELD OF THE INVENTION

The present invention relates generally to tie-down devices and, more specifically, tie-down devices that have various designs that incorporate the functional aspect of the tie-down device with other functional and visual properties.

### BACKGROUND OF THE INVENTION

Tie-down devices are well-known. Tie-down devices act as an anchor point for attaching one end of a strap, wire, rope, cord, etc. so that the remaining length of strap, wire, rope, cord, etc., can be used to secure a load or a vehicle. A common tie-down device is used in automotive vehicles and, in particular, pick-up trucks and sport-utility vehicles (SUV). The basic tie-down device has a generally triangular shape and includes a tab with at least one hole that allows a bolt or bolts to pass through for securing the tie-down device to a vehicle. (See FIG. 9 for an original equipment manufacturer replacement tie-down anchor.) The bolt is then screwed into a tapped screw hole made in the bed of the pick-up truck.

U.S. Pat. No. 8,277,157 discloses a type of prior art tie-down device that is commonly found on the roof of a sport-utility vehicle (SUV), or in the bed of a pick-up truck. This type introduces a linear mobility comprising a rail and a sliding block that can be locked at specific points along the rail.

Another well-known tie-down device is found at a marina, wharf, dock or similar marine setting. To prevent boats (or other marine equipment such as buoys) from floating off, a rope or cord secured to the boat is tied off to a secure ring, hook, or cleat that is bolted to a pier or similar structure.

Prior art or standard tie-down devices work for their intended purpose. However, virtually all prior art tie-downs consist of a ring or triangular-shaped loop that allows the strap or rope to pass there through. This design works well when there is only one strap or rope, or the object being secured is not so large or bulky so that the strap does not need to be thread through the loop multiple times.

Additionally, prior art tie-downs are merely functional and do not add to or complement the appearance of the vehicle.

Accordingly, there is a need for a tie-down that provides multiple places for the strap or rope to pass therethrough without affecting additional straps, or multiple passes by a single strap or rope.

### SUMMARY OF THE INVENTION

The present invention is tie-down device that is an improvement on traditional tie-downs from both a functional and from an visual standpoint. The present invention decreases the likelihood that a rope/strap will tangle by providing a separate pass-throughs in the tie-down for each individual rope/strap and is user-friendly.

Also, there is a substantial advantage to having the ability to isolate specific straps or ropes. For example, additional ropes can be added and secured to the tie-down using the multiple pass-throughs when the load changes thereby reducing time to maintain the knots and ropes. Additionally, the appearance of prior art tie-downs takes away from the overall appearance of the vehicle. In contrast, the tie-down device in accordance with the present invention can serve its primary purpose as an anchor point, and complement the surrounding area with a unique shape, or color.

Another unique feature of this invention is that the tie-downs can provide a significant surface area to allow writing to be placed on the tie-down. The wording can be instructions, a warning, advertising, or a favorite saying or proverb.

In the present invention, the tie-down can utilize the existing structure to secure the tie-down. For example, the subject invention can be designed to use the existing bolt/threaded hole used by original equipment manufacturers (Ford, Chevrolet, Toyota, etc.) of pick-up trucks.

It is important to emphasize that there are numerous mechanical configurations to attach the tie-down to a vehicle, pier, marina, etc. The most common design for the present invention is to use one or more bolt holes to allow the tie-down to be attached to a larger object. However, as mentioned previously, any means for securing the tie-down to a larger object falls within the scope of this invention.

It is not the goal of this invention to limit the scope to any one particular attachment means. It is the goal of this invention to emphasize, reiterate and claim, this invention teaches and includes a novel new tie down (specifically the cleat portion) that has additional functionality when compared to prior art tie-down devices.

### BRIEF DESCRIPTION OF THE DRAWINGS

The foregoing summary, as well as the following detailed description, may be better understood when read in conjunction with the accompanying drawings, which are incorporated in and form a part of the specification. The drawings serve to explain the principles of the invention and illustrate embodiments of the present invention that are preferred at the time the application was filed. It should be understood however that the invention is not limited to the precise arrangements and instrumentalities shown.

FIGS. 1A-1D are the front view, top view, right side view, and left side view, respectively, of a tie-down device in accordance with the present invention.

FIGS. 2A-2D are the front view, top view, right side view, and left side view, respectively, of a tie-down in accordance with the present invention that is designed to handle larger loads.

FIGS. 3A-3D are the front view, top view, right side view, and left side view, respectively, of a tie-down in accordance with the present invention having the shape of a heart.

FIGS. 4A-4D are the front view, top view, right side view, and left side view, respectively, of a tie-down in accordance with the present invention having the shape of an iron cross.

FIGS. 5A-5D are the front view, top view, right side view, and left side view, respectively, of a tie-down in accordance with the present invention having a relatively generic shape but with multiple pass throughs or apertures.

FIGS. 6A-6D are the front view, top view, right side view, and left side view, respectively, of a tie-down in accordance with the present invention.

FIGS. 7A-7D are the front view, top view, right side view, and left side view, respectively, of a tie-down device in accordance with the present invention resembling the shape of a human skull.

FIGS. 8A-8D are the front view, top view, right side view, and left side view, respectively, of a tie-down device in accordance with the present invention having a shape that brings to mind brass knuckles.

FIG. 9 is a picture of an original equipment manufacturer's (OEM) tie-down device used in a pick up truck.

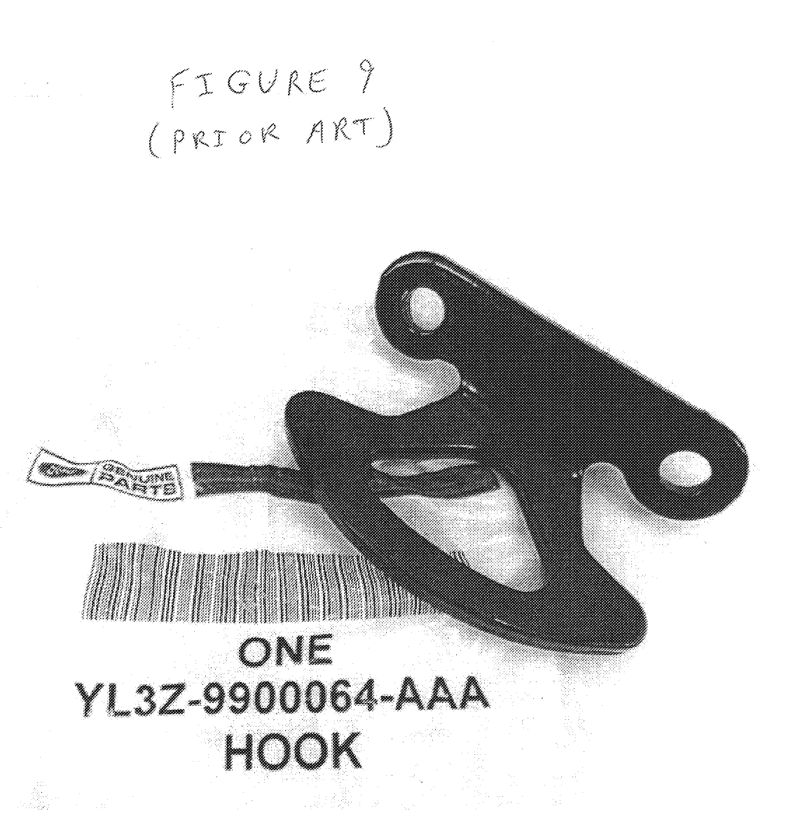

### DETAILED DESCRIPTION OF THE PREFERRED EMBODIMENT

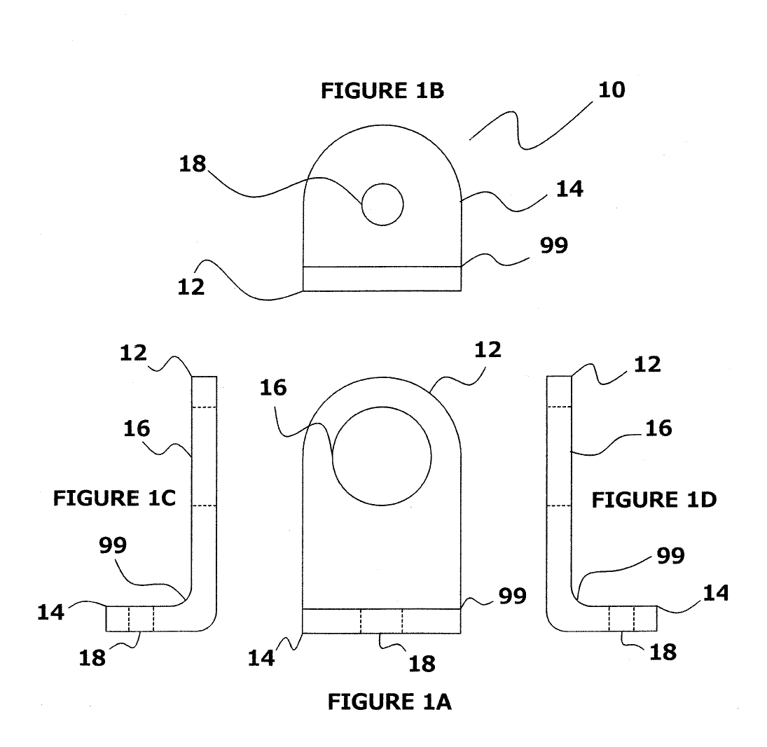

The present invention is illustrated by reference to FIGS. 1A through 8D. With reference to FIGS. 1A-1D, an embodiment of the present invention, tie-down 10, is illustrated. Referring to the front view FIG. 1A, tie-down 10 is composed of a generally oval-shaped base member, having a rounded top portion 12 having an angular orientation to base member 14. The top portion 12 comprises a pass-through 16. Fastening means, including ropes, straps, cords and the like are threaded through the pass-through 16, and may be secured to the tie-down 10 using knots or clips.

Referring to the top view 1B, the base portion 14 comprises an aperture 18 which is sized for an appropriately diameter bolt, rivet or other known securing means, depending on the use of the tie-down 10 and the load to be secured.

The angle 99 between the top portion 12 and the base portion 14 is illustrated as ninety degrees as is clearly illustrated in left side view and right side view FIGS. 1C and 1D, respectively; however, as one skilled in the art can appreciate, the angle may be changed depending on the use of the tie-down 10, and/or the type of load (i.e., shape, size, weight, etc.) to be secured.

Although a primary use of the tie-downs according to this invention is to replace original equipment manufacturers' (OEM) tie-downs in vehicles such as pick-up trucks and SUV's, the tie-down can be used anywhere a load needs to be secured (e.g., a trailer), or as an anchor point in a marine setting (e.g., for mooring a boat).

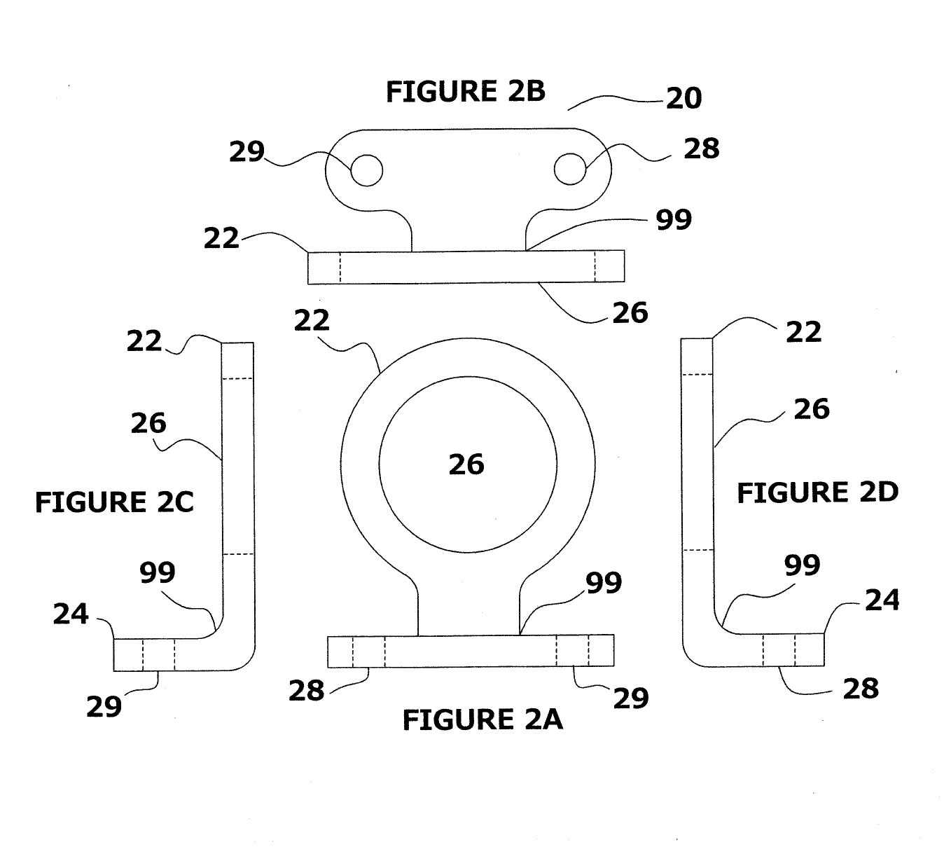

Referring now to FIGS. 2A-2D, 3A-3D and 4A-4D, tie-downs 20, 30 and 40, respectively, are illustrated. Tie-downs 20, 30 and 40 are each different embodiments of the subject invention. The embodiment of FIGS. 2A-2D is designed for use when there is a need to secure multiple ropes, straps or elastic cords, or the rope/strap/cord needed has a larger diameter (e.g., when hauling a large or unwieldy load). Referring again to front view FIG. 2B, the pass through 26 is larger to accommodate the multiple ropes/straps/cords. Otherwise, the structure of tie-down device 20 is similar to the structure of tie-down device 10.

As seen in FIGS. 2B-2C, a top portion 22 is in angular orientation with the base portion 24. The angle 99 is shown as 90 degrees but can be changed for a specific use.

U.S. Pat. No. 8,277,157, titled TIE-DOWN DEVICE, to David Allen Parsons, and assigned to Ford Motor Company, discloses a type of tie-down device that is designed to be used on a pick-up truck that utilizes a rail and sliding sled arrangement. Preferably two rails are attached on opposite sides, and extend the entire length of the bed. The tie-downs are attached to the sleds, and the sleds slide within the rails. A plurality of sled-like tie-downs are employed within each rail. U.S. Pat. No. 8,277,157 is hereby incorporated by reference as if fully set forth herein.

U.S. Pat. No. 9,499,088, titled VEHICLE TIE-DOWN CLEAT ASSEMBLY, to Patrick Fenchak, et al., and assigned to SRG Global, Inc., discloses a type of tie-down device that comprises a cleat attached to a base assembly wherein the base assembly is designed to be removably coupled to the storage compartment of a vehicle. The storage compartment of the vehicle has at least one aperture and two additional members configured to receive a lock member of the base assembly. The tie-down cleat disclosed in the '088 patent further includes a hinge that permits the cleat to rotate with respect to the base assembly. U.S. Pat. No. 9,499,088 is hereby incorporated by reference as if fully set forth herein.

As would be apparent to one skilled in the art, the subject invention can have its base portion 14 replaced by the identical or similar base assemblies for use in any rail type system or lock-member/aperture attachment means disclosed in U.S. Pat. No. 8,277,157 and/or U.S. Pat. No. 9,499,088, respectively.

As illustrated in FIGS. 2A-2D, and similar to tie-down 10, tie-down 20 is comprised of an upper portion 22 and base portion 24. Tie-down 20 being designed for heavier loads has a base portion 24 that resembles a cleat and includes multiple bolt holes. As shown in top view FIG. 2B, this embodiment employs exactly two bolt holes 28 and 29. If the tie down is intended to be used to secure an unusually large load, the base portion can be enlarged and additional bolt holes can be added. (The number and size of the bolts used to secure the tie-down can be modified to fit a pre-determined situation, such as copying the securing means used in OEM pick-up trucks.)

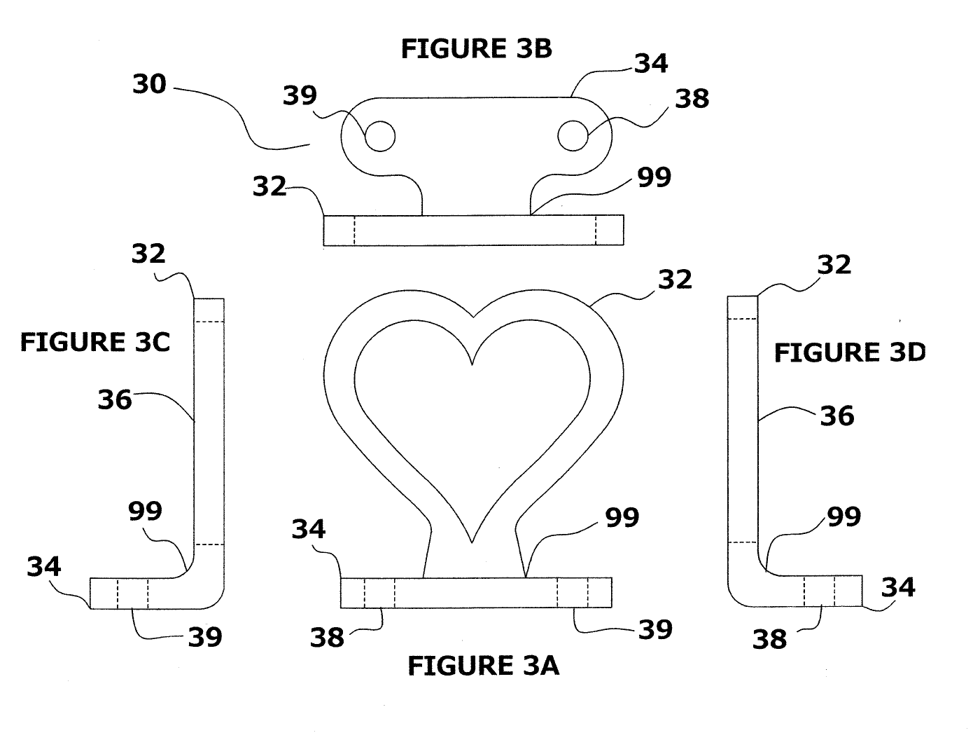

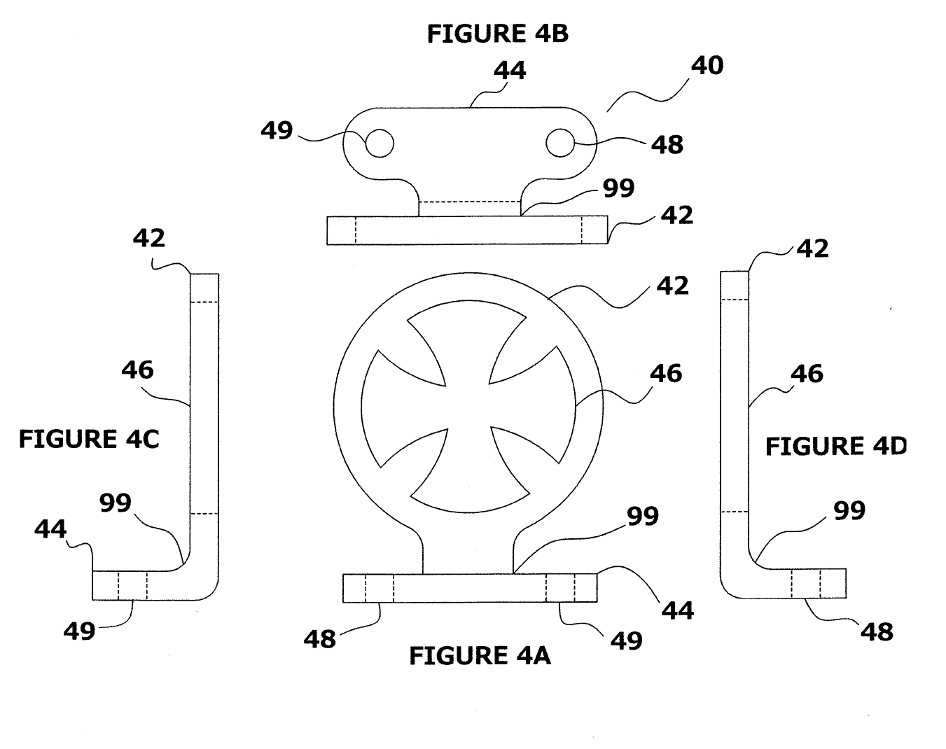

FIGS. 3A-3D and 4A-4D illustrate tie-downs 30 and 40, respectively, with decorative designs. While providing similar functionality as the two previous embodiments, the fanciful appearances of tie-downs 30 and 40 are readily apparent.

Referring now to FIGS. 3A-3D, a heart-shaped tie down 30, having a top portion 32 made in the shape of a heart, is illustrated. The shape is further emphasized by making pass-through 36 also in the shape of a heart. It should be noted that the theme of this tie-down can be emphasized further by painting the tie-down red or pink.

Tie-down 30 employs a cleat-like base portion 34. One or more bolt holes 38, and 39, are used to secure the tie-down 30 to a larger object such as a pick-up truck.

Although the decorative aspects are clearly observed, the tie-down 30 is fully functional, and the design is more than superficial. For example, with the cookie-cutter designs of pick-up trucks, the shape/size of the tie-downs can help an owner pick out his/her vehicle in a crowded parking lot.

Referring now to FIGS. 4A-4D, another decorative design is illustrated. As seen in front view FIG. 4A, a top portion 42 is formed in the shape of a circle—although the pass-through has the shape of an iron cross. As best seen in top view FIG. 4B, the base portion 44 is in the shape of a “T” or cleat. The design of the base portion 44 depends on the location and use of the tie-down. As is known by a person skilled in the art, the base portion can be made to accommodate a specific location by changing its size or shape, and increasing the number of holes 48, 49 used to accommodate bolts.

In addition, this embodiment illustrates an iron cross-like pass-through 46 as best illustrated in FIG. 4A. Unlike the heart-shaped tie-down in FIGS. 3A-3D, the embodiment of FIGS. 4A-4D illustrates a more generic top portion 42 (i.e., a circularly-shaped top portion) which can be initially cut using the basic program or CAD used to cut/make the tie-down illustrated in FIGS. 2A-2D. A person skilled in the art can appreciate that the shape of the perimeter of the top portion can be a generic shape (square, rectangle, triangle, etc.), a fanciful shape, or a customized shape.

By making the perimeter of the top portion 42 a generic shape (e.g., circular, square, rectangular, etc.), manufacturing costs and the time to manufacture each tie-down will be reduced. The pass-through 46 can be completely drilled, burned or cut at a later time, or also be made in a generic shape initially, and then refined or modified at a later time.

The manufacturing cost is lowered by manufacturing the perimeter of the top portion 42 to be a generic-shape (i.e., circular), since various different pass-through designs can be cut after the top portion is manufactured to a pre-determined size and shape, then storing the partially manufactured part until the pass-through design is decided upon. In this scenario, the tie-down manufacturer can quickly fill a large order placed by a customer since only the last step—that of cutting the pass-through 46—can be delayed until just before delivery of the order. This allows for the manufacturer to shift production in the case where one specific tie-down is more popular or there is a need to manufacture a specific tie-down for a client ordering hundreds or thousands of tie-downs.

Of course, the appearance or overall visual effect of the tie-down can be high-lighted by making the shape of the perimeter of the top portion (10, 20, or 40) substantially identical to the shape of the pass-through (or aperture). This manufacturing technique was used in the heart-shaped tie down 30 shown in FIG. 3A.

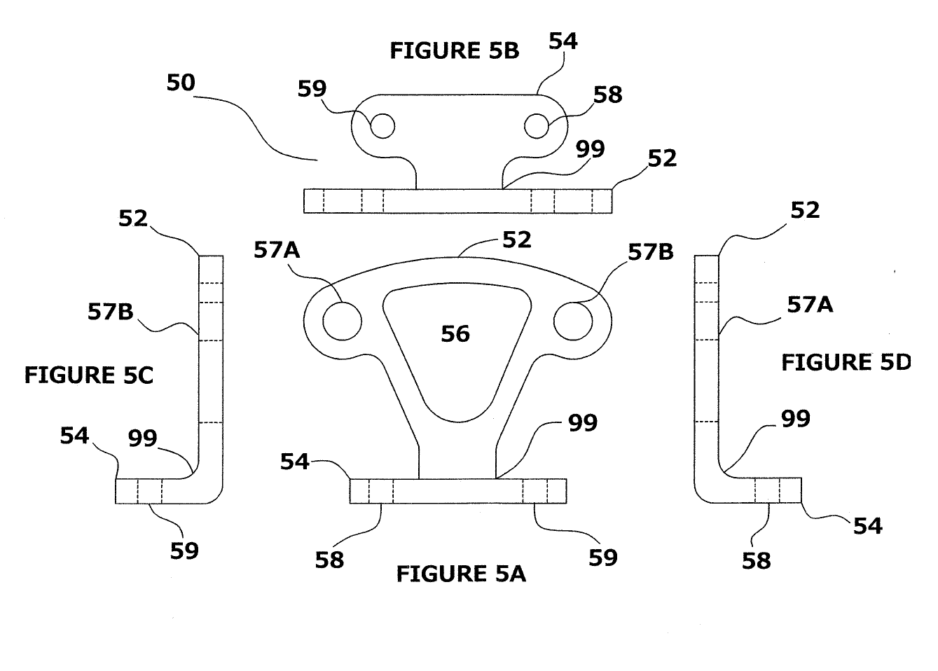

Referring now to FIGS. 5A-5D, another embodiment of a tie-down in accordance with the present invention is shown. The embodiment illustrated in FIGS. 5A-5D would be ideal for an OEM replacement in a pick-up truck. In particular, this embodiment is useful when the loads carried by the pick-up truck are large, non-standard and/or continually changing. For example, for a small business transporting trash/rubbish or for personal use when moving personal goods (a bed, dining room table, china cabinet, chairs, lawn mower, etc.).

As shown in front view FIG. 5A, the top portion 52 may include multiple pass-throughs, and/or pass-throughs of different sizes. The embodiment of FIGS. 5A-5D illustrate a relatively large pass-through 56 positioned between two smaller pass-throughs 57A and 57B. Although the embodiment shown in FIGS. 5A-5D is symmetrical, it should be noted that a different embodiment can have an asymmetrical top portion 52 in which all pass-throughs are shaped differently, and their location with respect to each other does not need to be symmetrical. For example, the tie-down of FIG. 5A may have both of the smaller pass-throughs 57A, 57B on one side with respect to the larger pass-through 56.

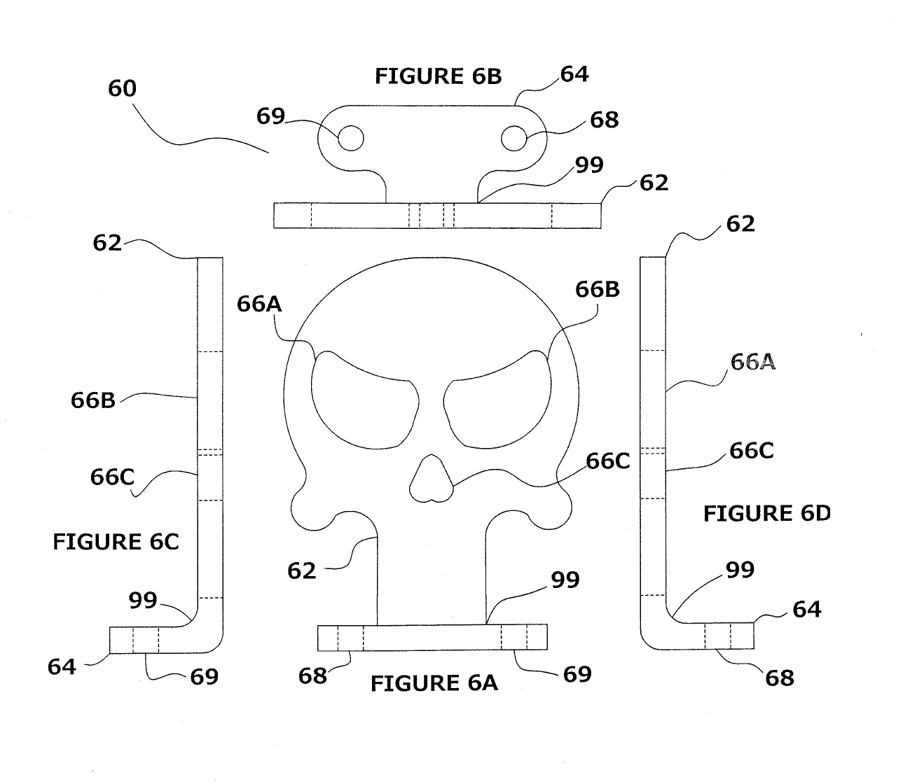

A more decorative or theme-based tie-down 60 is illustrated in FIGS. 6A-6D. This embodiment shows that more fanciful tie-downs (in this case, in the shape of a skull) may be made. The “eyes” of the skull form two pass-throughs 66A and 66B and the “nose” may also be used as a pass-through 66C. Again, as stated previously, neither the location of the pass-throughs or the shape of the top portion are required to be symmetrical. (It should go without saying that this tie-down 60 would be particularly desirable around Halloween to provide a useful and decorative device.) Other fanciful designs can include a bunny rabbit, Santa Claus' face, or the mascot of a local school. After the fanciful tie-downs are manufactured, they can be painted appropriately.

The tie-down 60 illustrated in FIGS. 6A-6D also shows an embodiment in which the top portion 62 can have a custom design while the pass-throughs 66A, 66B, and 66C can be a completely different shape/design. (In contrast, with the tie down 20 of FIG. 2A, the pass-through 26, has the same general shape as the top portion 22, i.e., a heart.) Pass-throughs 66A, 66B, and 66C are designed to enhance and make the overall image of the tie-down 60.

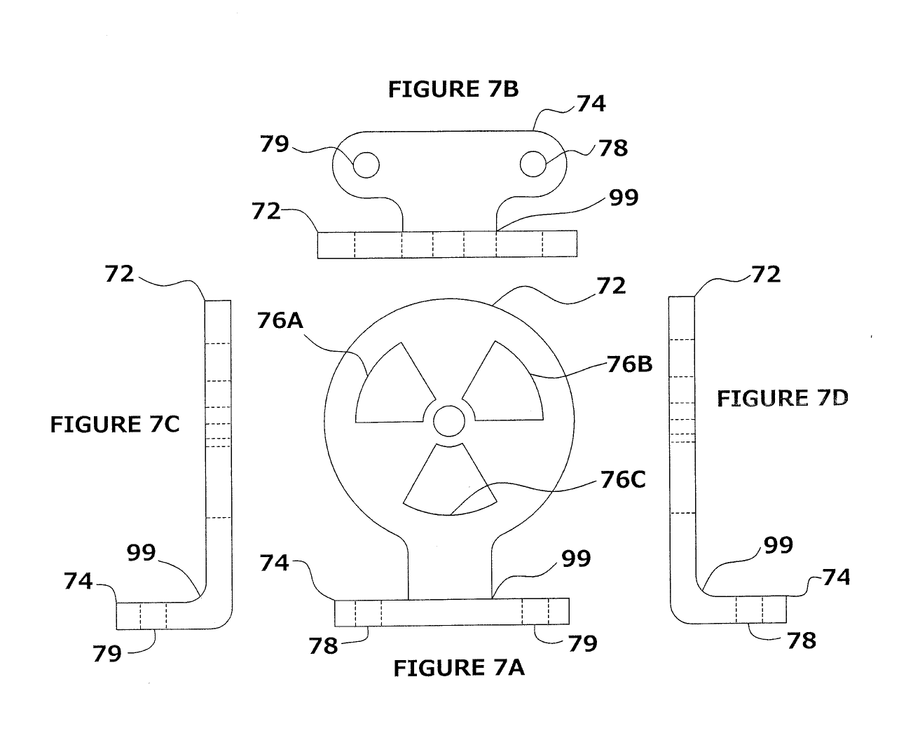

Referring to FIGS. 7A-7D, an embodiment in which the tie-down 70 serves a dual use by also conveying a message—in this case, a bio-hazard or nuclear hazard. This embodiment is only meant as an example of a multiple-use tie down. The top portion 72 includes pass-throughs 76A, 76B and 76C faint the radiating portions of the international nuclear symbol. The “message” can be further emphasized by painting the tie-down a particular color. (In this case, a bright red or orange would highlight the potential danger of transporting hazardous waste.)

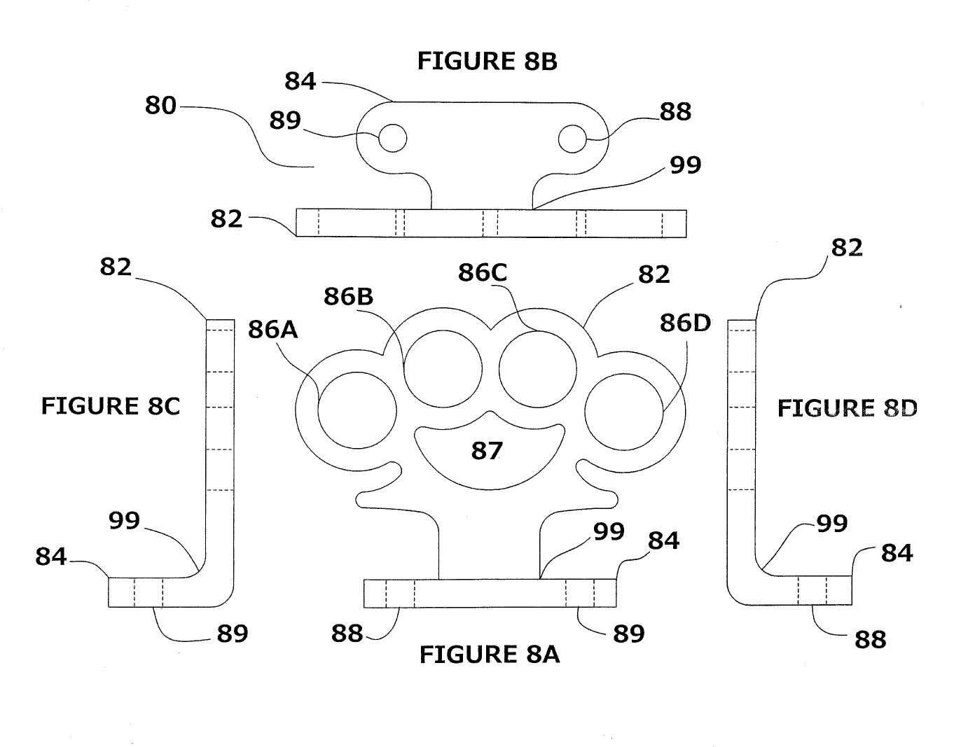

Another fanciful embodiment is illustrated in FIGS. 8A-8D. In this embodiment, the top portion 82 is manufactured in the shape of “brass knuckles.” The holes in which fingers are normally inserted are used as pass-throughs 86A-86D. An additional pass-through 87, or multiple pass-throughs, can be added if needed.

The brass knuckle shape is for illustrative purposes only. It is meant to disclose that a useful design can be incorporated into the top portion of a tie-down; for example, a hammer, screw driver, or a box wrench could be appropriate dual-function shapes. With computed aided design and computer aided cutters, the shapes and designs of tie-downs are limited only by the imagination.

It should be noted that all embodiments illustrated herein exhibit that the base portion (14, 24, 34, etc.) has an angular orientation with respect to their corresponding top portions (12, 22, 32, etc.). As one skilled in the art will appreciate, the angle 99 may be changed to suit a specific usage. For example, some situations may require a 30 degree or a 45 degree angle. The angle may be eliminated completely (zero degrees) or the angle may be inverted from that shown in the Figures (e.g., minus 30 degrees).

In another embodiment of the subject invention, the tie down may have different colors. The color may convey information to the user. For example, if used in a marina, different colors (or different shades of the same color), can indicate the depth of the water near a dock or the distance to a specific point. For example, light blue could indicate a water depth of one foot or less, while darker blues indicate a deeper water depth. Alternatively, a boat owner can paint the tie-down distinctive colors (rainbow), in order to make it stand out allowing the boat owner to quickly locate his property or mooring spot. In this manner, painting a distinctively-shaped tie down allows the subject invention to serve multiple utilitarian functions.

Also, if the top portion or base portion is large enough, the tie down may include wording or phrases to further make the tie down useful. One phrase that comes to mind can indicate the maximum load or force that can be applied to the tie down. Other wording may give additional warning such as when used on the international radioactive tie down of FIGS. 7A-7D. Of course, instructions or advertising may also be printed on the tie-down (e.g., promoting the pick-up truck owner's business).

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

I claim:

1. A tie-down that serves as an anchor point for securing a rope, strap, wire or similar flexible strip, said tie-down comprising:
a) a top portion;
b) at least one pass-through in said top portion for permitting a rope to be threaded therethrough
b) a base portion; and
c) means associated with said base portion for securing the tie-down to a separate structure.

2. The tie-down of claim 1 wherein said means for securing comprises at least one hole for accommodating a bolt.

3. The tie-down of claim 1 wherein said top portion is in the shape of a heart.

4. The tie-down of claim 3 wherein said pass-through is in the shape of a heart.

5. The tie-down of claim 1 painted in a manner that improves its aesthetics.

6. The tie-down of claim 1 further comprising writing printed on said tie-down.

7. A tie-down that serves as an anchor point for securing a rope, strap, wire or similar flexible strip, said tie-down comprising:
a) a top portion;
b) at least one pass-through in said top portion for permitting a rope or strap to be threaded therethrough
b) a base portion in angular orientation to the top portion; and
c) means associated with said base portion for securing the tie-down to a vehicle.

8. The tie-down of claim 7 wherein the vehicle is a pick-up truck.

9. The tie-down of claim 8 wherein said top portion has a desired shape.

10. The tie-down of claim 9 wherein said desired shape is a heart.

11. The tie-down of claim 9 wherein said desired shape incorporates a word or phrase.
